(19) United States
(12) Patent Application Publication
(10) Pub. No.: US 2014/0307911 A1
(43) Pub. Date: Oct. 16, 2014

(54) EAR PAD AND EARPHONE DEVICE

(71) Applicant: FUNAI ELECTRIC CO., LTD., Osaka (JP)

(72) Inventor: Takeshi INODA, Osaka (JP)

(73) Assignee: FUNAI ELECTRIC CO., LTD., Osaka (JP)

(21) Appl. No.: 14/248,384

(22) Filed: Apr. 9, 2014

(30) Foreign Application Priority Data
Apr. 15, 2013 (JP) 2013-085147

(51) Int. Cl. H04R 1/10

(52) U.S. Cl. CPC H04R 1/1091; H04R 1/1016
USPC 381/380

(57) ABSTRACT

An ear pad to be attached to an earphone device including a speaker includes: a main body including a sound hole through which a sound from the speaker comes out; a protrusion which is made of the same material as the main body and protrudes outwardly from a side surface of the main body; and a surrounding part which is made of the same material as the main body and is formed at an outer end portion of the protrusion to surround the main body, the outer end portion being positionally opposite to an end portion of the protrusion that is located on the side surface of the main body.

### CROSS REFERENCE TO RELATED APPLICATION

The present application is based on and claims priority of Japanese Patent Application No. 2013-085147 filed on Apr. 15, 2013. The entire disclosure of the above-identified application, including the specification, drawings and claims is incorporated herein by reference in its entirety.

### FIELD

The present invention relates to an ear pad and an earphone device including the ear pad.

### BACKGROUND

FIG. 12 is a diagram showing a conventional earphone device. An earphone device 2 includes a main body 200 which is vertically long and has an approximately rectangular-parallelepiped shape. The main body 200 has a projecting part 20 that includes a speaker. The projecting part 20 includes a sound hole through which a sound from the speaker comes out.

A user attaches an ear pad 1 to the projecting part 20 of the earphone device 2 to use the earphone device 2. Then, the user attaches the projecting part 20 of the earphone device 2 having the ear pad 1 thereon to the ear of the user. With this, the user can hear a sound from the earphone device 2.

FIG. 13 is a perspective view showing a configuration of a conventional ear pad. An ear pad 100 includes a main body 101. In the center of the main body 101, a sound hole 101A is formed. Moreover, an approach surface 101S is formed on the surface of the main body 101. The approach surface 101S comes close to the entrance of the ear canal of the user when the ear pad 100 is attached to the ear of the user.

On the back side of the ear pad 100, an opening 101B is formed. The projecting part 20 of the earphone device 2 (see FIG. 12) is to be fitted into this opening 101B. The user inserts the projecting part 20 of the earphone device 2 into the opening 101B of the ear pad 100 and then attaches this ear pad 100 to the ear in such a manner to bring the approach surface 101S of the ear pad 100 close to the entrance of the ear canal. With this, a sound from the speaker reaches the ear of the user through the sound hole of the projecting part 20 of the earphone device 2 and the sound hole 101A of the ear pad 100.

Here, when the approach surface 101S of the ear pad 100 is kept close to the entrance of the ear canal, the user is likely to lose a sense of balance because the sound coming out through the sound hole 101A is hard to flow to the outside of the ear. Moreover, since airflow between the entrance of the ear canal and the outside of the ear is poor, the user is easily affected by a feeling of aural fullness.

With this being the situation, a slit 102 is formed on the approach surface 101A of the ear pad 100 in order for the sound coming out through the sound hole 101A to escape to the outside of the ear. This way, since the slit 102 allows the sound coming out through the sound hole 101A to escape to the outside of the ear, the user is less likely to lose a sense of balance. Moreover, with the enhanced air permeability, the user is not easily affected by a feeling of aural fullness any more. Such a technique of forming a slit on an approach surface is disclosed in Japanese Unexamined Patent Application Publication No. 2008-521320 (Patent Literature 1).

Furthermore, Japanese Unexamined Patent Application Publication No. 2009-49841 (Patent Literature 2) discloses that a plurality of threadlike members are formed on the outer surface of an ear insertion part. The threadlike members are enlarged in diameter when the user stands up, and are reduced in diameter when the user inclines the user's body. Furthermore, Registered Utility Model Publication No. 3161011 (Patent Literature 3) discloses the canal-shaped earphone device having an uneven outer surface. According to the techniques disclosed in Patent Literatures 2 and 3, airflow between the inside and the outside of the ear is enhanced, thereby making the user hardly feel aural fullness.

### SUMMARY

### Technical Problem

In the case of Patent Literature 1 where a slit is formed on the approach surface, the thickness of the ear pad body is reduced by the depth of the formed slit. Due to this reduced thickness, the ear pad body may be broken.

In the case of Patent Literature 2 where a plurality of threadlike members are formed on the outer surface of the ear insertion part, the ear insertion part and the threadlike member are made of respective different materials. Therefore, manufacturability is low, meaning that the cost is likely to increase.

In the case of Patent Literature 3 where the outer surface of the earphone device body is uneven, the earphone device itself is a canal-type device which is to be inserted directly into the ear canal. Therefore, as compared with an open-ear-type device, air permeability is lower.

The present invention is conceived to solve the aforementioned problems, and has an object to provide an ear pad which is robust and has excellent air permeability.

### Solution to Problem

In order to achieve the above object, an ear pad according to an aspect of the present invention is an ear pad to be attached to an earphone device including a speaker, the ear pad including: a main body including a sound hole through which a sound from the speaker comes out; a protrusion which is made of a same material as the main body and protrudes outwardly from a side surface of the main body; and a surrounding part which is made of the same material as the main body and is formed at an outer end portion of the protrusion to surround the main body, the outer end portion being positionally opposite to an end portion of the protrusion that is located on the side surface of the main body.

This configuration includes: the protrusion that protrudes outwardly from the side surface of the main body of the ear pad; and the surrounding part that is formed at the protrusion to surround the main body. Thus, an airflow path is formed between the main body and the surrounding part.

This results in enhancement in air permeability. Moreover, a sound coming out through the sound hole of the main body is led to the outside of the ear through the airflow path. This can make the user hardly lose a sense of balance.

Furthermore, the main body of the ear pad, the protrusion, and the surrounding part are all made of the same material. Thus, the ear pad can be integrally formed. This high manufacturability result in a cost reduction.

Moreover, any processing such as forming a slit is not performed on the main body. Therefore, the rigidity of the main body can be maintained.

Accordingly, an ear pad which is robust and has excellent air permeability can be provided at low cost.

Furthermore, the surrounding part may have an outward force directed from the side surface of the main body.

With this configuration, since the surrounding part has the outward force directed from the side surface of the main body, a force of the ear pad to stay in the ear is increased. Thus, the fit of the ear pad can be enhanced.

Moreover, the main body is substantially cylindrical in shape, and the protrusion protrudes outwardly from the side surface of the main body in a radial direction of the main body.

With this configuration, the main body is substantially cylindrical in shape, and the protrusion protrudes outwardly from the side surface of the main body in the radial direction of the main body. Thus, when the ear pad is attached to the ear, the protrusion helps the ear support the ear pad. Accordingly, the fit of the ear pad can be enhanced.

Furthermore, the main body may include an approach surface which comes close to an entrance of an ear canal of a user when the ear pad is fitted into an ear hole of the user, the approach surface being provided with the sound hole.

With this configuration, the main body includes the approach surface which comes close to the entrance of the ear canal of the user when the ear pad is fitted into the ear hole of the user, the approach surface being provided with the sound hole. Thus, when the ear pad is fitted into the ear hole of the user, a sound outputted from the earphone device easily reaches the eardrum of the user. On this account, the user can easily hear a sound from the earphone device.

Moreover, the protrusion and the surrounding part may be formed to be located closer to the earphone device than the approach surface when the ear pad is attached to the earphone device.

With this configuration, the protrusion and the surrounding part are formed to be located closer to the earphone device than the approach surface when the ear pad is attached to the earphone device.

Thus, when the ear pad is attached to the ear of the user, the surrounding part is located at the position corresponding to the parts (such as the tragus, the cavity of concha, and the cymba conchae) located close to the ear canal of the user. Therefore, the fit of the ear pad is enhanced.

Furthermore, the surrounding part may be formed to be located at a position corresponding to a cavity of concha of a user when the ear pad is attached to an ear of the user.

With this configuration, when the ear pad is attached to the ear of the user, the surrounding part is fitted into the cavity of concha of the user. Therefore, the fit of the ear pad can be further enhanced.

Moreover, an ear pad according to another aspect of the present invention is an ear pad to be attached to an earphone device including a speaker, the ear pad including: a main body including a sound hole through which a sound from the speaker comes out; and at least three protrusions made of a same material as the main body and formed on the main body.

With this configuration, an airflow path leading from the entrance of the ear canal to the outside of the ear of the user is formed by integrally forming the main body and at least the three protrusions. Thus, the ear pad having excellent air permeability can be provided at low cost.

Furthermore, each of the protrusions may protrude outwardly from a side surface of the main body.

With this configuration, each of the protrusions protrudes outwardly from the side surface of the main body.

Thus, when the ear pad is attached to the ear of the user, the airflow path leading from the entrance of the ear canal to the outside of the ear of the user is formed by the protrusions. This can accordingly enhance air permeability.

Moreover, the ear pad may further include a surrounding part which is made of the same material as the main body and is formed at outer end portions of the protrusions to surround the main body, each of the outer end portions being positionally opposite to an end portion, located on the side surface of the main body, of a corresponding one of the protrusions.

With this configuration, at the end portions of the protrusions, the surrounding part is formed to surround the main body. Thus, the fit of the ear pad can be more enhanced as compared with the case where the protrusions come in direct contact with the ear of the user.

Furthermore, the main body may be substantially cylindrical in shape, and each of the protrusions may protrude outwardly from the side surface of the main body in a radial direction of the main body.

With this configuration, the main body is substantially cylindrical in shape, and each of the protrusions protrudes outwardly from the side surface of the main body in the radial direction of the main body. Thus, when the ear pad is attached to the ear of the user, the protrusions help the ear support the ear pad. Accordingly, the fit of the ear pad can be enhanced.

Moreover, the main body may include an approach surface which comes close to an entrance of an ear canal of a user when the ear pad is fitted into an ear hole of the user, the approach surface being provided with the sound hole.

With this configuration, the main body includes the approach surface which comes close to the entrance of the ear canal of the user when the ear pad is fitted into the ear hole of the user, the approach surface being provided with the sound hole. Thus, when the ear pad is fitted into the ear hole of the user, a sound outputted from the earphone device easily reaches the eardrum of the user. On this account, the user can easily hear a sound from the earphone device.

Furthermore, each of the protrusions may be an elastic member.

With this configuration, since each of the protrusions is an elastic member, the fit of the ear pad in the ear can be enhanced.

Moreover, at least one of the three protrusions may be formed at a position corresponding to a cavity of concha of a user.

With this configuration, at least one of the three protrusions is fitted into the cavity of concha of the user, the fit of the ear pad in the ear can be further enhanced.

Furthermore, the ear pad may further include a connector which connects at least two of the protrusions, wherein the connector is an elastic member.

With this configuration, at least two protrusions are connected via the connector which is an elastic member, and the connector thus functions like a spring. Accordingly, the fit of the ear pad in the ear can be further enhanced.

Moreover, each of the protrusions protrudes from the approach surface in a direction perpendicular to the approach surface.

With this configuration, when the ear pad is attached to the ear of the user, the protrusions are positioned to protrude from the approach surface of the main body toward the entrance of the car canal. Thus, an airflow path leading from the entrance of the ear canal to the outside of the ear of the user is formed by the protrusions. This can accordingly enhance air permeability. Moreover, a sound coming out through the sound hole of the main body is led to the outside of the ear through the airflow path. This can make the user hardly lose a sense of balance.

The earphone device according to another aspect of the present invention includes the ear pad described above. Therefore, the advantageous effect described above can also be achieved.

### Advantageous Effects

The present invention can provide an ear pad which is robust and has excellent air permeability.

### BRIEF DESCRIPTION OF DRAWINGS

These and other objects, advantages and features of the invention will become apparent from the following description thereof taken in conjunction with the accompanying drawings that illustrate a specific embodiment of the present invention.

[FIG. 1]

FIG. 1 is a diagram explaining a structure of an ear of a user.

[FIG. 2]

FIG. 2 is a plan view showing an ear pad according to Embodiment 1 of the present invention.

[FIG. 3]

FIG. 3 is a diagram explaining how the ear pad and an earphone device are connected, (a) showing the state before the ear pad is attached to the earphone device and (b) showing the state after the ear pad is attached to the earphone device.

[FIG. 4]

FIG. 4 is a plan view showing an example of a configuration of an ear pad according to Embodiment 2 of the present invention.

[FIG. 5]

FIG. 5 is a perspective view showing an example of a configuration of an ear pad according to Embodiment 3 of the present invention.

[FIG. 6]

FIG. 6 is a perspective view showing an example of a configuration of an ear pad according to Embodiment 4 of the present invention.

[FIG. 7]

FIG. 7 is a diagram showing an example of a configuration of an ear pad according to Embodiment 5 of the present invention, (a) showing a perspective view of the ear pad, (b) showing a side view of the ear pad, and (c) showing a plan view of the ear pad.

[FIG. 8]

FIG. 8 is a diagram showing an example of a configuration of an ear pad according to Embodiment 6 of the present invention, (a) showing a perspective view of the ear pad, (b) showing a side view of the ear pad, and (c) showing a plan view of the ear pad.

[FIG. 9]

FIG. 9 is a diagram showing an example of a configuration of an ear pad according to Embodiment 7 of the present invention, (a) showing a perspective view of the ear pad, (b) showing a side view of the ear pad, and (c) showing a plan view of the ear pad.

[FIG. 10]

FIG. 10 is a diagram schematically illustrating a usage example of the ear pad shown in FIG. 9.

[FIG. 11]

FIG. 11 is a perspective view showing an example of a configuration of an ear pad according to Embodiment 8 of the present invention.

[FIG. 12]

FIG. 12 is a diagram showing a conventional earphone device.

[FIG. 13]

FIG. 13 is a perspective view showing a configuration of a conventional ear pad.

### DESCRIPTION OF EMBODIMENTS

Hereafter, certain exemplary embodiments are described in greater detail with reference to the drawings. Each of the exemplary embodiments described below only shows a preferred example. Structural elements, connection of the structural elements, and so forth shown in the following exemplary embodiments are merely examples, and therefore do not limit the scope of the present invention. The present invention is determined by the scope of the appended Claims. Therefore, among the structural elements in the following exemplary embodiments, structural elements not cited in any one of the independent claims are not necessarily required to achieve the object in the present invention. However, these structural elements are described to implement more preferred embodiments.

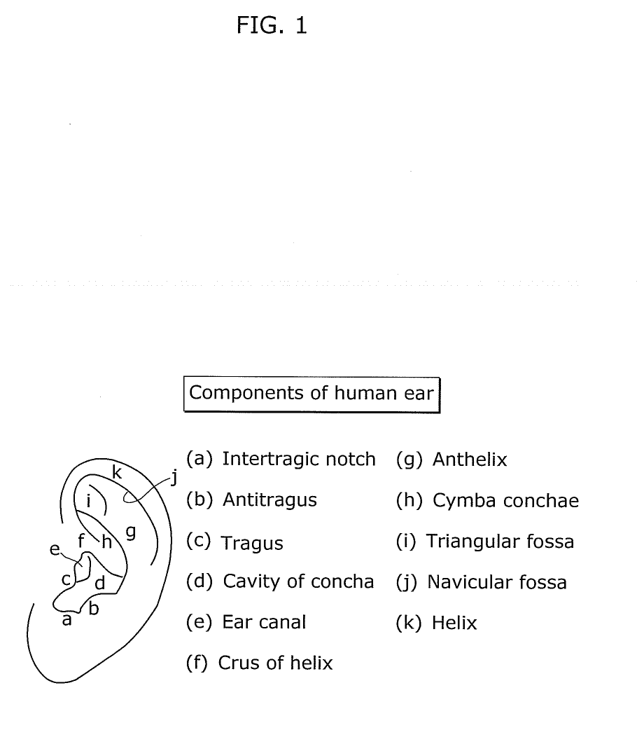

Before the exemplary embodiments of the present invention are described, a structure of a user's ear to which an ear pad is to be attached is firstly described. FIG. 1 is a diagram explaining the structure of the ear of the user.

As shown in FIG. 1, the ear of the user includes an intertragic notch (a), an antitragus (b), a tragus (c), a cavity of concha (d), an ear canal (e), a crus of helix (f), an anthelix (g), a cymba conchae (h), a triangular fossa (i), a navicular fossa (j), and a helix (k).

The following describes an ear pad and an earphone device according to the embodiments of the present invention.

### Embodiment 1

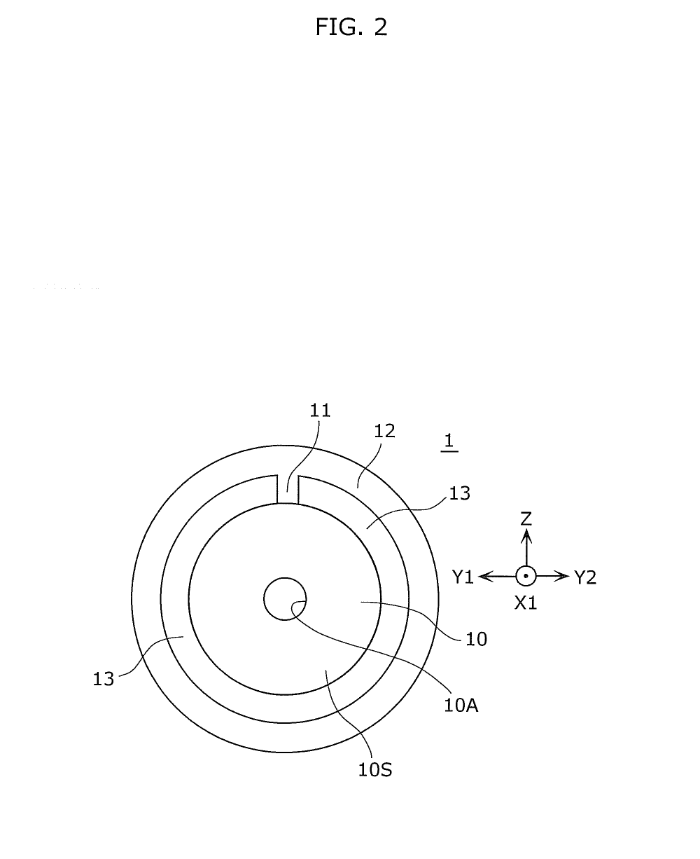

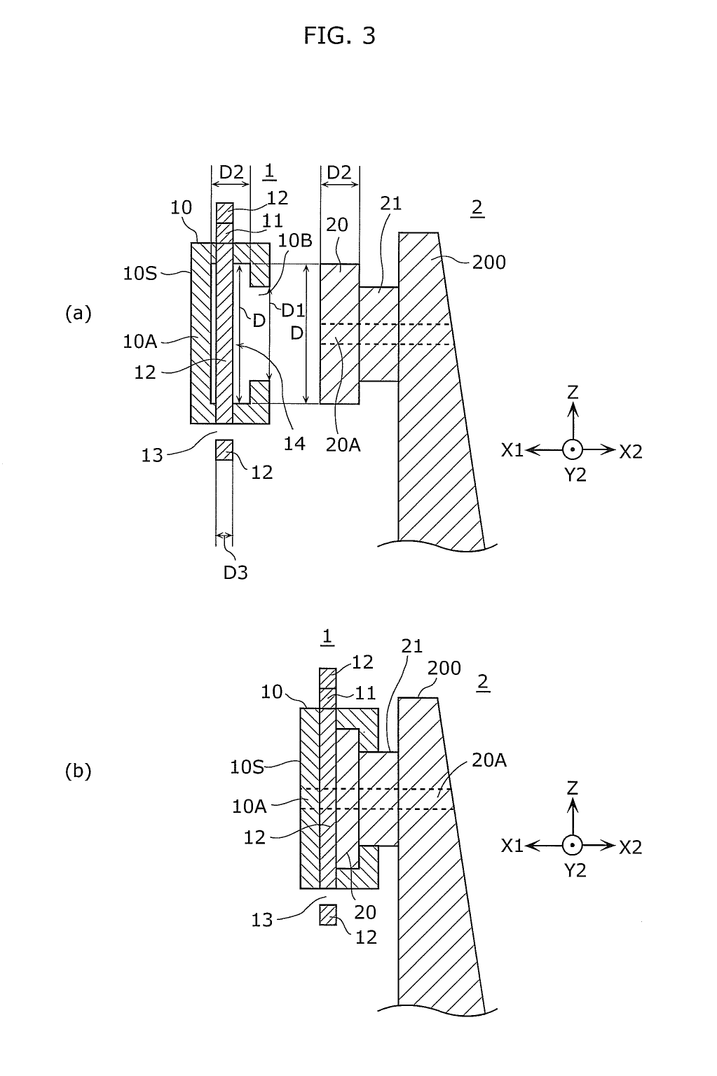

FIG. 2 is a plan view showing an ear pad according to Embodiment 1 of the present invention. FIG. 3 is a diagram explaining how the ear pad and an earphone device are connected, (a) showing the state before the ear pad is attached to the earphone device and (b) showing the state after the ear pad is attached to the earphone device.

In the following, an arrow X1 indicates the direction toward the inside of the ear, and an arrow X2 indicates the direction toward the outside of the ear. Moreover, an arrow Y1 indicates the left-hand direction of an ear pad 1 and an earphone device 2, and an arrow Y2 indicates the right-hand direction of the ear pad 1 and the earphone device 2. Furthermore, an arrow Z indicates the height direction of the ear pad 1 and the earphone device 2.

The ear pad 1 includes a main body 10 which is substantially cylindrical in the direction from the inside to the outside of the ear. The main body 10 includes a sound hole 10A at the center thereof. A sound from a speaker included in the earphone device 2 comes out through this sound hole 10A.

The main body 10 further includes an approach surface 10S which comes close to the entrance of the ear canal of the user when the ear pad 1 is fitted into the ear hole of the user.

A protrusion 11 is formed to protrude outwardly from the outer surface (the side surface) of the main body 10 in the radial direction of the main body 10. The protrusion 11 is made of the same material as the main body 10. A surrounding part 12 is formed at the radially outer end portion of the protrusion 11 to surround the main body 10. The surrounding part 12 is also made of the same material as the main body 10. With this configuration, an airflow path 13 leading from the entrance of the ear canal (e) to the outside of the ear is formed.

Air trapped at the entrance of the ear canal (e) flows to the outside of the ear through the sound hole 10A and the airflow path 13. A sound coming out of the sound hole 10A also flows to the outside of the ear through the airflow path 13.

The surrounding part 12 is formed at a position corresponding to at least the cavity of concha (d) of the user. To be more specific, the surrounding part 12 is located so as to be fitted into the cavity of concha (d) when the user attaches the ear pad 1 into the ear hole of the user.

The cavity of concha (d) is located further outward than the entrance of the ear canal (e). For this reason, the protrusion 11 and the surrounding part 12 are formed to be in more external positions than the approach surface 10S with respect to the ear hole.

The main body 10 is approximately equal in diameter to the entrance of the ear canal (e) of the user. The surrounding part 12 is larger in diameter than the ear canal (e), and is approximately equal in diameter to a region surrounded by the antitragus (b), the crus of helix (f), and the cymba conchae (h).

As shown in FIG. 2 and FIG. 3, the ear pad 1 includes the approach surface 10S that comes close to the entrance of the ear canal (e) of the user when the ear pad 1 is fitted into the ear hole of the user. The ear pad 1 further includes a hollow 14 having a substantially cylindrical shape into which a projecting part 20 is to be fitted. The diameter of the hollow 14 is equal to a diameter D of the projecting part 20, so that the projecting part 20 is tightly fitted into the hollow 14.

In a more external position with respect to the ear hole, the ear pad 1 further includes an opening 10B into which the projecting part 20 of the earphone device 2 is to be fitted. A diameter D1 of the opening 10B is smaller than the diameter D of the projecting part 20 in order for the projecting part 20 fitted into the hollow 14 to be firmly held.

The earphone device 2 includes a main body 200 having a supporting member 21. Here, the projecting part 20 is supported by the supporting member 21. A length D2 of the projecting part 20 in the direction from the outside to the inside of the ear is equal to a length D2 of the hollow 14 in the direction from the outside to the inside of the ear. With this, the projecting part 20 is tightly fitted into the hollow 14 of the ear pad 1.

The sound hole 10A of the ear pad 1 is formed at a position corresponding to a sound hole 20A of the earphone device 2. Thus, when the ear pad 1 is attached to the projecting part 20, the sound hole 10A and the sound hole 20A are connected to each other.

The earphone device 2 outputs, from the speaker, a sound received from a phone (a mobile phone or a fixed-line phone) on the other end of the line, via wireless communication with a mobile phone of the user who is wearing the earphone device 2. In this wireless communication, Bluetooth (registered trademark) which is one of the short-range wireless communication standards may be used for example.

The ear pad 1 is attached to the projecting part 20 of the earphone device 2 as follows, for example. The user firstly holds and presses the surrounding part 12 of the ear pad 1 from both sides to expand the diameter D1 of the opening 10B in the height direction. Then, the user puts one of the right-hand or left-hand end portion of the projecting part 20 into the opening 10B. Here, since the projecting part 20 is partly placed into the opening 10B, the length of the opening 10B is accordingly increased in the horizontal direction. Thus, the user puts the remaining part (i.e., the end portion of the other side) of the projecting part 20 into the increased length of the opening 10B. As a result, the projecting part 20 of the earphone device 2 is tightly fitted into the hollow 14 as shown in (b) of FIG. 3 since the diameter D of the hollow 14 is larger than the diameter D1 of the opening 10B.

The surrounding part 12 has an outward force directed from the side surface of the main body 10 in the radial direction. On this account, when the ear pad 1 where the projecting part 20 is fitted as shown in (b) of FIG. 3 is inserted into the ear hole of the user, the surrounding part 12 is fitted into the ear hole of the user. Moreover, with the force of the surrounding unit 12, the ear pad 1 is held in the ear hole of the user.

In this way, the protrusion 11 and the surrounding part 12 both of which are made of the same material as the main body 10 allow the ear pad 1 to be held in the ear hole of the user. Therefore, the fit of the ear pad 1 can be enhanced at low cost. Moreover, the airflow path 13 leading from the entrance of the ear canal (e) to the outside of the ear is formed as a result of forming the protrusion 11 and the surrounding part 12 both of which are made of the same material as the main body 10. Therefore, air permeability can be enhanced at low cost.

The sound coming out through the sound hole 10A is led to the outside of the ear by passing between the main body 10 and the surrounding part 12, i.e., passing through the airflow path 13. With this, the user is less likely to lose a sense of balance. In addition, the main body 10, the protrusion 11, and the surrounding part 12 of the ear pad 1 are all made of the same material. Thus, the ear pad 1 can be integrally formed. This high manufacturability result in a cost reduction.

Moreover, any processing such as forming forming a slit is not performed on the main body 10. Therefore, the rigidity of the main body 10 can be maintained.

Accordingly, the ear pad 1 which is robust and has excellent air permeability can be provided at low cost.

### Embodiment 2

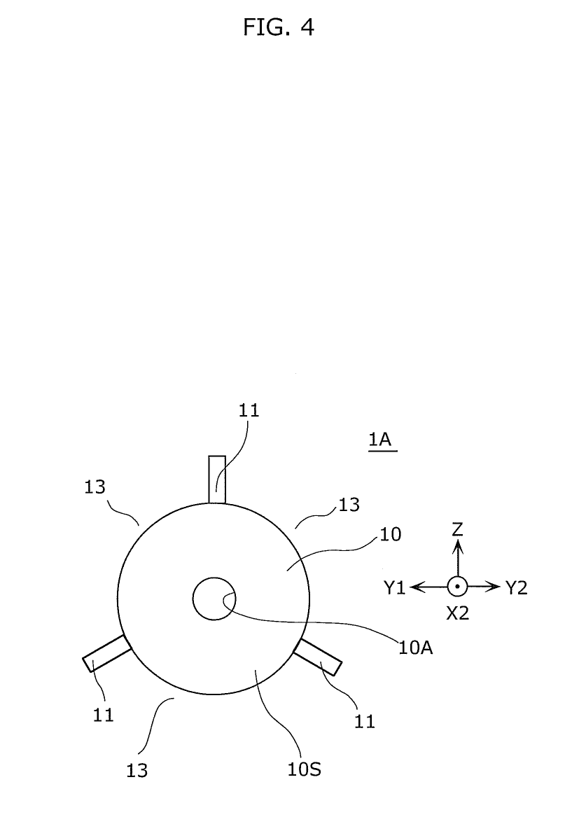

FIG. 4 is a plan view showing an example of a configuration of an ear pad according to Embodiment 2 of the present invention. An ear pad 1A includes three protrusions 11 formed to protrude outwardly from the outer surface (the side surface) of a main body 10 in the radial direction of the main body 10. The three protrusions 11 are formed to be in more external positions (in the X axis direction) than an approach surface 10S with respect to the ear hole. Each of the protrusions 11 is an elastic member.

One of the protrusions 11 is formed at a position corresponding to the cavity of concha (d) of the user. To be more specific, this protrusion 11 is formed to be fitted into the cavity of concha (d) of the user when the ear pad 1A is attached to the ear of the user. The ear pad 1 including the protrusions 11 is larger in diameter than the ear canal (e), and is approximately equal in diameter to a region surrounded by the antitragus (b), the crus of helix (f), and the cymba conchae (h). Here, an airflow path 13 is formed between adjacent ones of the protrusions 11.

With this configuration, when the ear pad 1A is fitted into the ear hole of the user to allow the approach surface 10S of the main body 10 to come close to the entrance of the ear canal (e), one of the protrusions 11 is fitted into the cavity of concha (d) of the user. Therefore, the fit of the ear pad 1A can be enhanced. In addition, since air flows between the inside and outside of the ear through the airflow path 13, air permeability is enhanced.

In addition, each of the protrusions 11 is made of the same material as the main body 10. Thus, the ear pad 1A can be integrally formed. This high manufacturability result in a cost reduction.

### Embodiment 3

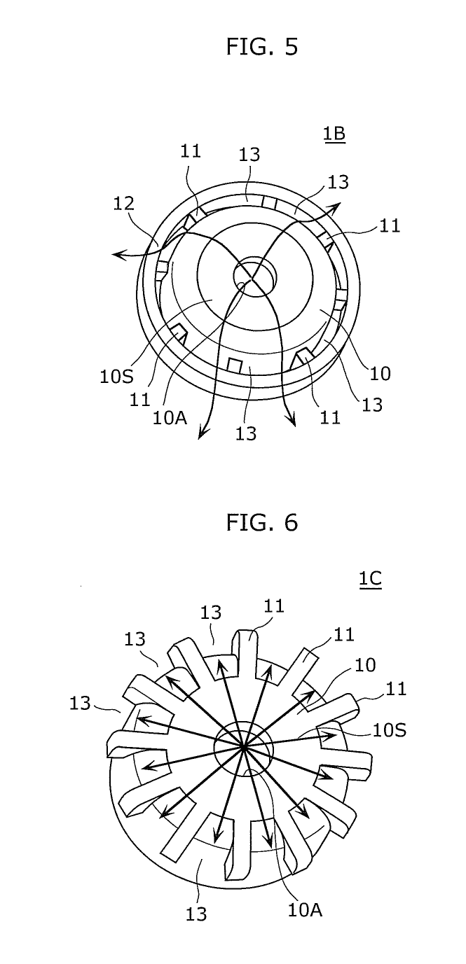

FIG. 5 is a perspective view showing an example of a configuration of an ear pad according to Embodiment 3 of the present invention. An ear pad 1B includes four protrusions 11 formed to protrude outwardly from the outer surface (the side surface) of a main body 10 in the radial direction of the main body 10. The four protrusions 11 are formed at intervals of 90 degrees with respect to the center of the main body 10. The four protrusions 11 are formed to be in more external positions than an approach surface 10S with respect to the ear hole (in the direction perpendicular to the plane of the present diagram).

A surrounding part 12 is formed, at the radially outer end portions of the protrusions 11, in the shape of a ring to surround the main body 10. The surrounding part 12 is formed at a position corresponding to the cavity of concha (d) of the user when the ear pad 1B is attached to the ear of the user. Moreover, the surrounding part 12 is larger in diameter than the ear canal (e), and is approximately equal in diameter to a region surrounded by the antitragus (b), the crus of helix (f), and the cymba conchae (h).

With this configuration, the ring-shaped surrounding part 12 is fitted into the cavity of concha (d) of the user (see FIG. 1). Thus, as compared with the case where the protrusion 11 itself is to be fitted into the cavity of concha (d), a pressure on the cavity of concha (d) is reduced. This can further enhance the fit of the ear pad 1B.

### Embodiment 4

FIG. 6 is a perspective view showing an example of a configuration of an ear pad according to Embodiment 4 of the present invention. An ear pad 1C includes twelve protrusions 11 which are formed at intervals of 30 degrees with respect to the center of a main body 10. The twelve protrusions 11 are formed to be in more external positions than an approach surface 10S with respect to the ear hole (in the direction perpendicular to the plane of the present diagram).

With this configuration, the number of protrusions 11 which come in contact with the cavity of concha (d) of the user (see FIG. 1) is larger as compared with the ear pad 1A shown in FIG. 4. This can further enhance the fit of the ear pad 1C.

### Embodiment 5

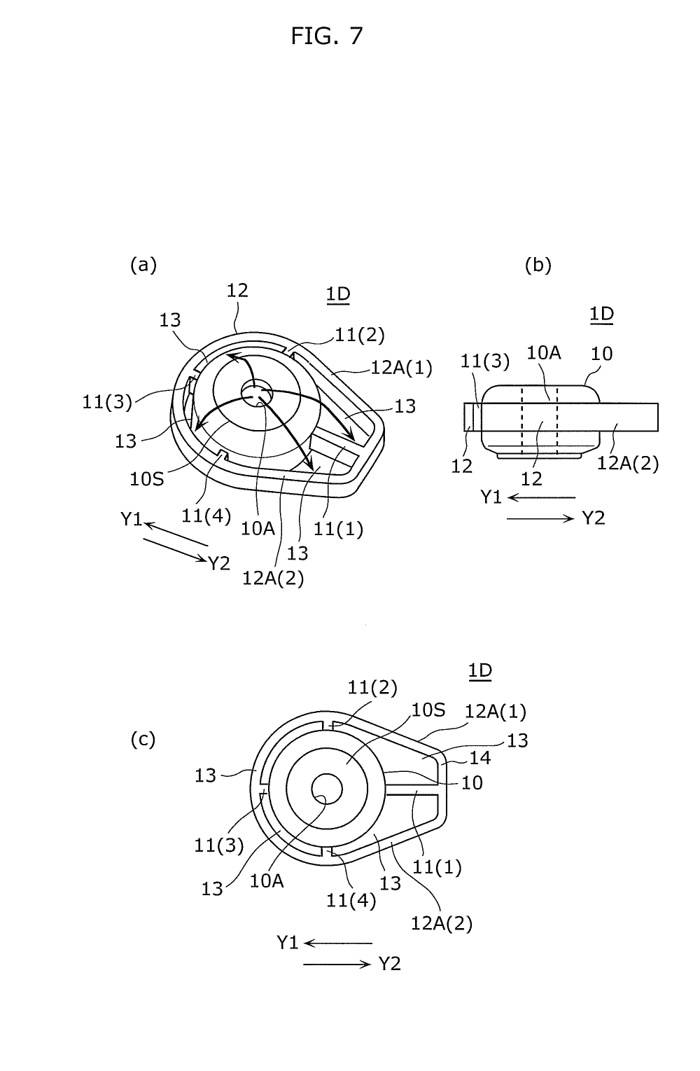

FIG. 7 is a diagram showing an example of a configuration of an ear pad according to Embodiment 5 of the present invention, (a) showing a perspective view of the ear pad, (b) showing a side view of the ear pad, and (c) showing a plan view of the ear pad.

An ear pad 1D includes four protrusions 11 (1) to 11 (4) which are formed on the side surface of a main body 10 at intervals of 90 degrees with respect to the center of the main body 10. Of the protrusions, the protrusion 11 (1) protruding in the right-hand direction (in the direction of the arrow Y2) is formed longer than the other three protrusions 11 (2), 11 (3), and 11 (4).

A surrounding part 12 is formed at the radially outer end portions of the protrusions 11 to surround the main body 10. The surrounding part 12 is larger in diameter than the ear canal (e), and is approximately equal in diameter to a region surrounded by the antitragus (b), the crus of helix (f), and the cymba conchae (h). The protrusions 11 (1) to 11 (4) and the surrounding part 12 are formed to be in more external positions than an approach surface 10S with respect to the ear hole (in the direction perpendicular to the plane of the present diagram).

When the ear pad 1D is attached to the ear of the user, the protrusion 11 (1) is located corresponding to the cavity of concha (d) and the protrusion 11 (2) is located corresponding to the crus of helix (f). Moreover, the protrusion 11 (3) is located corresponding to the tragus (c), and the protrusion 11 (4) is located corresponding to the antitragus (b).

Here, a distance from the entrance of the ear canal (e) to each of the antitragus (b), the tragus (c), and the crus of helix (f) is shorter than a distance from the entrance of the ear canal (e) to the cavity of concha (d). On account of this, the lengths of the protrusions 11 (2), 11 (3), and 11 (4) are made shorter than the length of the protrusion 11 (1) in the radial direction of the main body 10.

Moreover, as described above, the distance from the entrance of the ear canal (e) to each of the antitragus (b), the tragus (c), and the crus of helix (f) is shorter than the distance from the entrance of the ear canal (e) to the cavity of concha (d). On account of this, portions of the surrounding part 12 that are connected to the protrusions 11 (2), 11 (3), and 11 (4) are formed not so elastic, thereby preventing too much airflow from the entrance of the ear canal to the outside of the ear.

The surrounding part 12 further includes a connector 12A (1) connecting the protrusions 11 (1) and 11 (2) and a connector 12A (2) connecting the protrusions 11 (1) and 11 (4).

Each of the connectors 12A (1) and 12A (2) needs to be fitted into into the cavity of concha (d) that is located farther from the entrance of the ear canal (e) than the antitragus (b), the tragus (c), and the crus of helix (f). For this reason, the length of the protrusion 11 (1) supporting the connectors 12A (1) and 12A (2) is formed longer than the lengths of the protrusions 11 (2) to 11 (4) in the radial direction of the main body 10.

Each of the connectors 12A (1) and 12A (2) is an elastic member. With the elasticity, each of the connectors 12A (1) and 12A (2) is tightly fitted into the cavity of concha (d).

With this configuration, the connectors 12A (1) and 12A (2) both of which are the elastic members allow the ear pad 1D to be tightly fitted into the cavity of concha (d) of the user. Therefore, the fit of the ear pad 1D can be enhanced. Moreover, an airflow path 13 leading from the entrance of the ear canal (e) of the user to the outside of the ear enhances air permeability.

### Embodiment 6

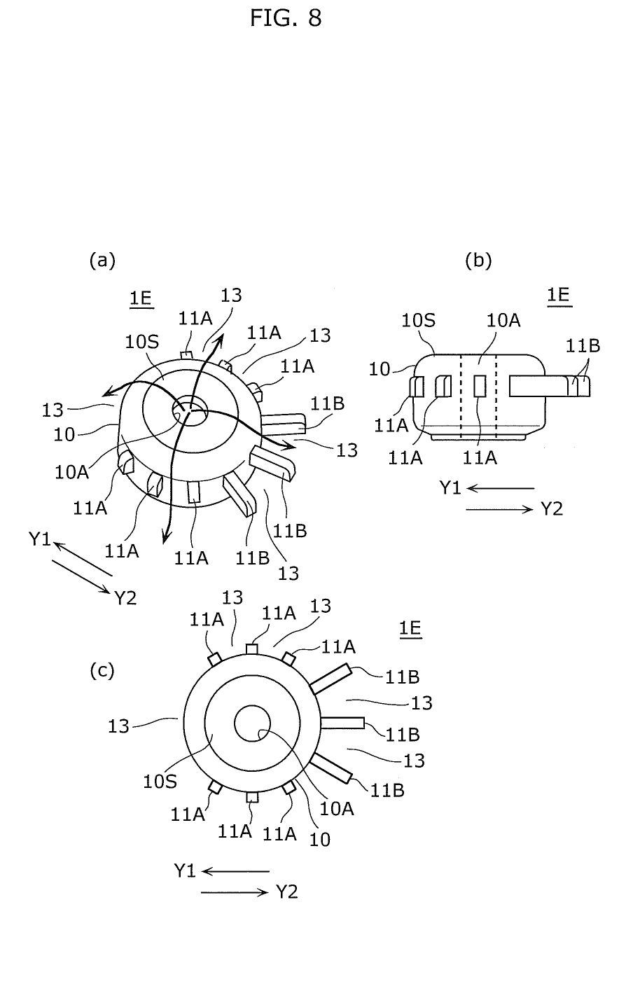

FIG. 8 is a diagram showing an example of a configuration of an ear pad according to Embodiment 6 of the present invention, (a) showing a perspective view of the ear pad, (b) showing a side view of the ear pad, and (c) showing a plan view of the ear pad.

An ear pad 1E includes three protrusions 11A on each side surface in the direction perpendicular to the horizontal direction of a main body 10. Here, these two sets of three protrusions 11A are formed symmetric with respect to the center line of the main body 10. Moreover, three protrusions 11B are formed on the right-hand side surface (in the direction indicated by the arrow Y2) of the main body 10. Each of the three protrusions 11B are longer than the protrusions 11A in the radial direction of the main body 10. The protrusions 11A and 11B are formed to be in more external positions than an approach surface 10S with respect to the ear hole (in the direction perpendicular to the plane of the present diagram).

The ear pad 1E including the protrusions 11A and 11B is larger in diameter than the ear canal (e) of the user, and is approximately equal in diameter to a region surrounded by the antitragus (b), the crus of helix (f), and the cymba conchae (h).

When the ear pad 1E is fitted into the ear of the user, each set of the three protrusions 11A is located at the positions corresponding to the components (such as the antitragus (b), the tragus (c), and the crus of helix (f)) close to the entrance of the ear canal (e). On the other hand, the protrusions 11B need to be fitted into the cavity of concha (d) that is located farther from the entrance of the ear canal (e). For this reason, the lengths of the protrusions 11B are formed longer than the lengths of the protrusions 11A. Here, at least the protrusions 11B are elastic members.

With this configuration, since the protrusions 11B are fitted into the cavity of concha (d), the ear pad 1E can be tightly fitted into the ear of the user. In addition, an airflow path 13 is formed between adjacent ones of the protrusions 11A and between adjacent ones of the protrusions 11B. Thus, air permeability is enhanced.

### Embodiment 7

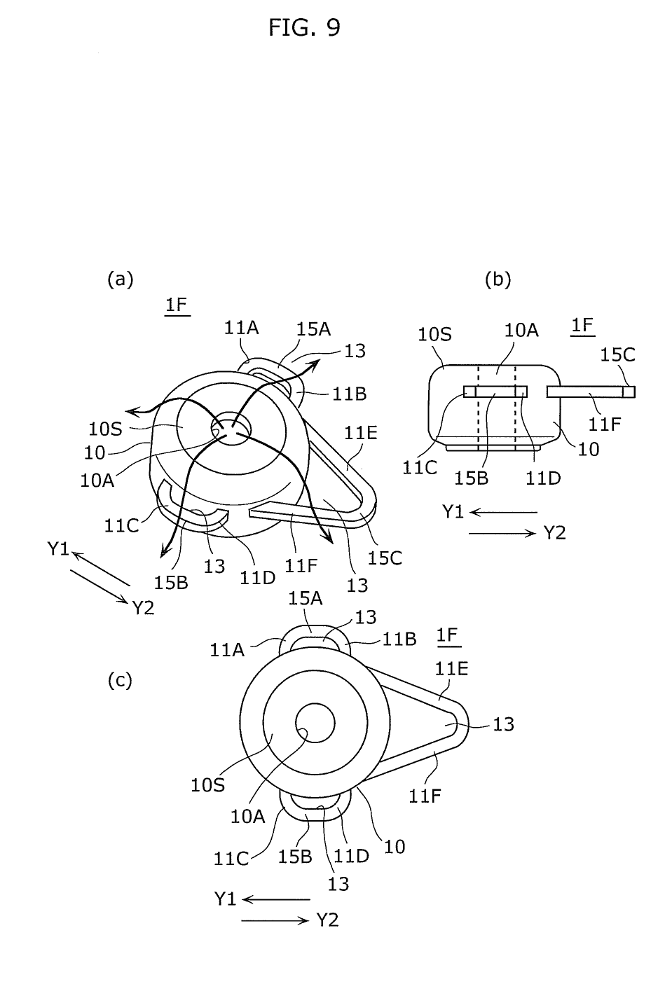

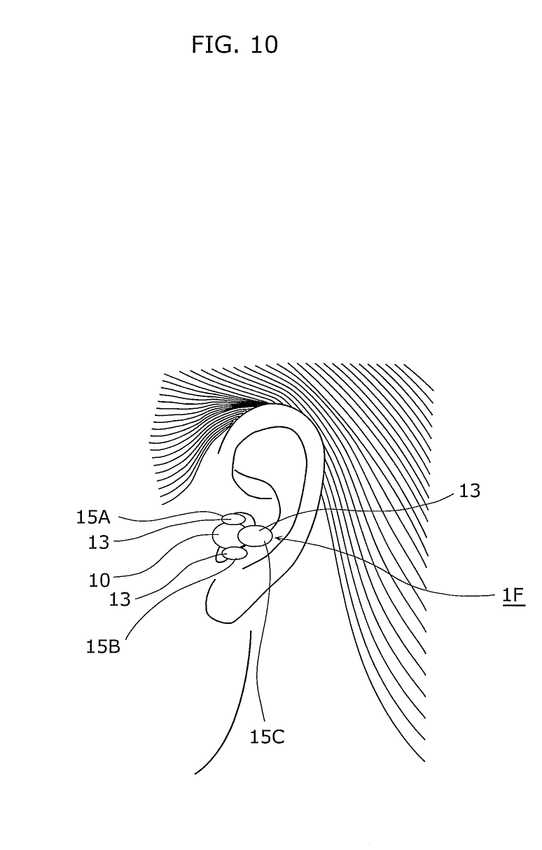

FIG. 9 is a diagram showing an example of a configuration of an ear pad according to Embodiment 7 of the present invention, (a) showing a perspective view of the ear pad, (b) showing a side view of the ear pad, and (c) showing a plan view of the ear pad.

An ear pad 1F includes six protrusions 11A to 11F on the side surface a main body 10. Here, a set of the protrusions 11A and 11B is formed symmetric to a set of the protrusions 11C and 11D with respect to the center line of the main body 10. Moreover, the six protrusions 11A to 11F are formed to be in more external positions than an approach surface 10S with respect to the ear hole (in the direction perpendicular to the plane of the present diagram).

The protrusions 11A and 11B are connected by a connector 15A. The protrusions 11C and 11D are connected by a connector 15B. The protrusions 11E and 11F are connected by a connector 15C.

When the ear pad 1F is fitted into the ear of the user, the connectors 15A and 15B are located at the positions corresponding to the components (such as the antitragus (b), the tragus (c), and the crus of helix (f)) close to the entrance of the ear canal (e). In other words, the protrusions 11A to 11D do not have to be so long in the radial direction of the main body 10. On the other hand, the connector 15C needs to be fitted into the cavity of concha (d) that is located farther from the entrance of the ear canal (e). For this reason, the lengths of the protrusions 11E and 11F are formed longer than the lengths of the protrusions 11A to 11D in the radial direction of the main body 10. Here, at least the protrusions 11E and 11F and the connector 15C are elastic members.

With this configuration, since the protrusions 11E and 11F and the connector 15C which are all elastic are fitted into the cavity of concha (d), the ear pad 1F can be tightly fitted into the ear of the user. In addition, an airflow path 13 is formed between the protrusions 11A and 11B, between the protrusions 11C and 11D, and between the protrusions 11E and 11F. Thus, air permeability is enhanced.

FIG. 10 is a diagram schematically illustrating a usage example of the ear pad 1F shown in FIG. 9. When the ear pad 1F is attached to the ear of the user: the connector 15A comes in contact with the crus of helix (f); the connector 15B comes in contact with the antitragus (b); and the connector 15C and the protrusions 11E and 11F are fitted into the cavity of concha (d).

In such a state, air flows between the entrance of the ear canal (e) and the outside of the ear through the airflow paths 13. Thus, the fit of the ear pad 1F is enhanced. In addition, the protrusions 11E and 11F and the connector 15C which are elastic like springs are fitted into the cavity of concha (d). Therefore, the ear pad 1F can be tightly fitted into the ear of the user.

### Embodiment 8

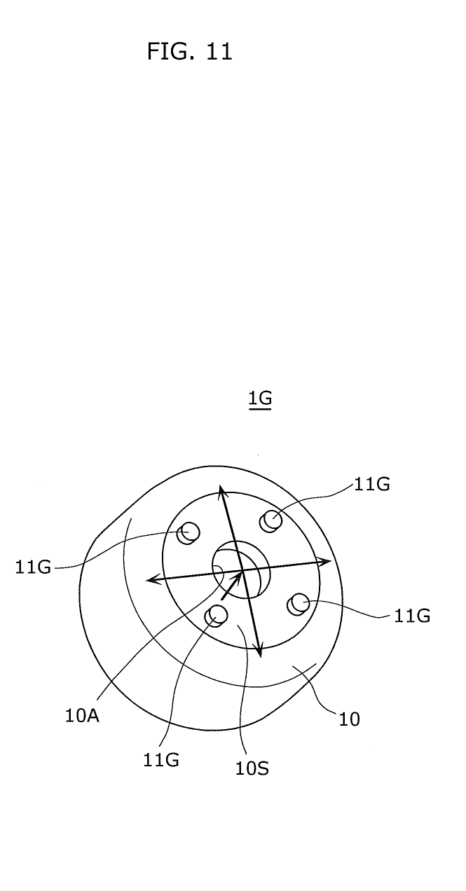

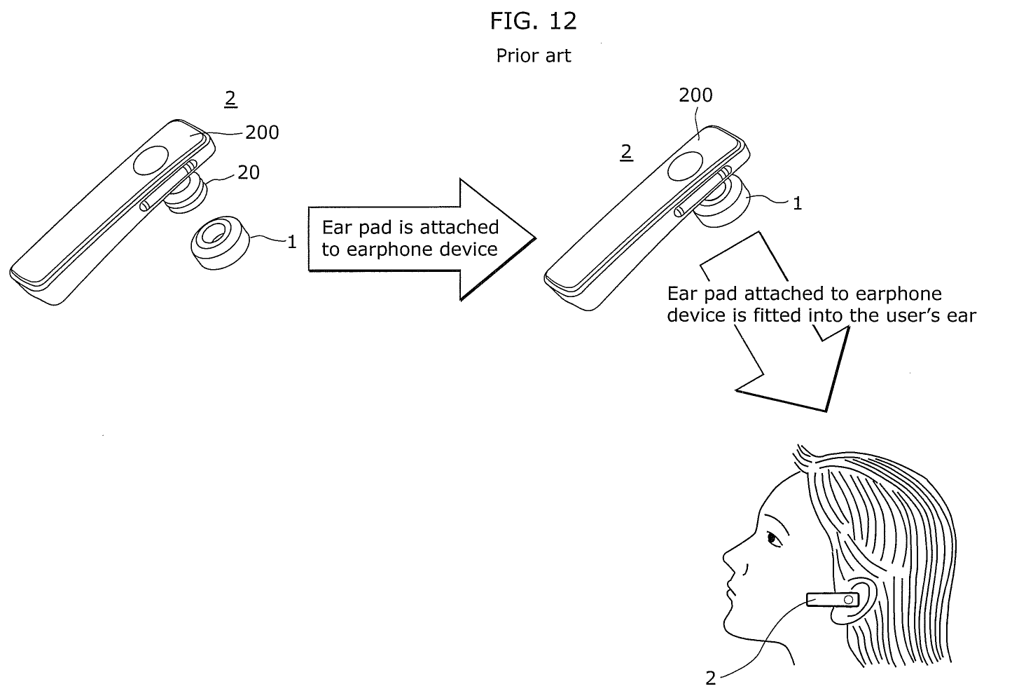

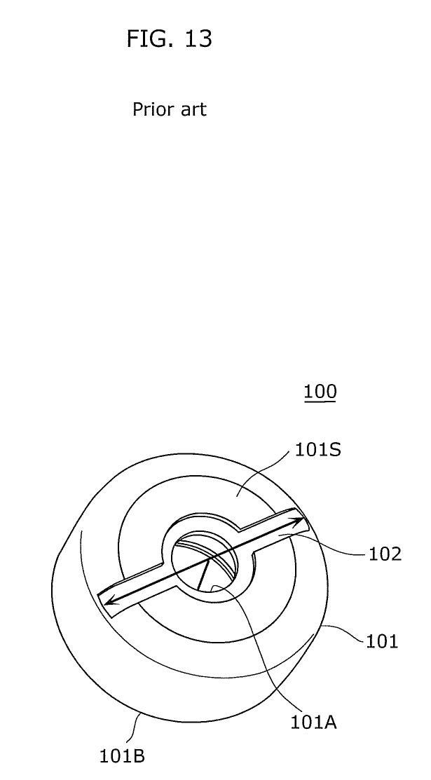

FIG. 11 is a perspective view showing an example of a configuration of an ear pad according to Embodiment 8 of the present invention.

An ear pad 1G includes four protrusions 11G which protrude outwardly from an approach surface 10S in the direction perpendicular to the approach surface 10S, i.e., the direction from the approach surface 10S toward the entrance of the ear canal (e) of the user. With this configuration, an airflow path leading form the entrance of the ear canal (e) of the user to the outside of the ear is also formed by the four protrusions. Thus, the fit of the ear pad 1G can be enhanced.

Although only some exemplary embodiments of the present invention have been described in detail above, those skilled in the art will readily appreciate that many modifications are possible in the exemplary embodiments without materially departing from the novel teachings and advantages of the present invention. Accordingly, all such modifications are intended to be included within the scope of the present invention.

### INDUSTRIAL APPLICABILITY

The present invention disclosed herein is advantageously applicable to earphone devices used with mobile phones capable of handsfree communication with another phone at the other end of the line.

1. An ear pad to be attached to an earphone device including a speaker, the ear pad comprising:
a main body including a sound hole through which a sound from the speaker comes out;
a protrusion which is made of a same material as the main body and protrudes outwardly from a side surface of the main body; and
a surrounding part which is made of the same material as the main body and is formed at an outer end portion of the protrusion to surround the main body, the outer end portion being positionally opposite to an end portion of the protrusion that is located on the side surface of the main body.

2. The ear pad according to claim 1,
wherein the surrounding part has an outward force directed from the side surface of the main body.

3. The ear pad according to claim 1,
wherein the main body is substantially cylindrical in shape, and
the protrusion protrudes outwardly from the side surface of the main body in a radial direction of the main body.

4. The ear pad according to claim 1,
wherein the main body includes an approach surface which comes close to an entrance of an ear canal of a user when the ear pad is fitted into an ear hole of the user, the approach surface being provided with the sound hole.

5. The ear pad according to claim 4,
wherein the protrusion and the surrounding part are formed to be located closer to the earphone device than the approach surface when the ear pad is attached to the earphone device.

6. The ear pad according to claim 1,
wherein the surrounding part is formed to be located at a position corresponding to a cavity of concha of a user when the ear pad is attached to an ear of the user.

7. An ear pad to be attached to an earphone device including a speaker, the ear pad comprising:
a main body including a sound hole through which a sound from the speaker comes out; and
at least three protrusions made of a same material as the main body and formed on the main body.

8. The ear pad according to claim 7,
wherein each of the protrusions protrudes outwardly from a side surface of the main body.

9. The ear pad according to claim 8, further comprising
a surrounding part which is made of the same material as the main body and is formed at outer end portions of the protrusions to surround the main body, each of the outer end portions being positionally opposite to an end portion, located on the side surface of the main body, of a corresponding one of the protrusions.

10. The ear pad according to claim 8,
wherein the main body is substantially cylindrical in shape, and
each of the protrusions protrudes outwardly from the side surface of the main body in a radial direction of the main body.

11. The ear pad according to claim 7,
wherein the main body includes an approach surface which comes close to an entrance of an ear canal of a user when the ear pad is fitted into an ear hole of the user, the approach surface being provided with the sound hole.

12. The ear pad according to claim 7,
wherein each of the protrusions is an elastic member.

13. The ear pad according to claim 7,
wherein at least one of the three protrusions is formed at a position corresponding to a cavity of concha of a user.

14. The ear pad according to claim 7, further comprising
a connector which connects at least two of the protrusions,
wherein the connector is an elastic member.

15. The ear pad according to claim 11,
wherein each of the protrusions protrudes from the approach surface in a direction perpendicular to the approach surface.

16. An earphone device including the ear pad according to claim 1.
